(19) United States
(12) Patent Application Publication
(10) Pub. No.: US 2014/0221534 A1
(43) Pub. Date: Aug. 7, 2014

(54) TUNNELING ANNULUS GROUT

(71) Applicant: Jesse Osborne, JR., Sagamore Hills, OH (US)

(72) Inventor: Jesse Osborne, JR., Sagamore Hills, OH (US)

(21) Appl. No.: 13/943,097

(22) Filed: Jul. 16, 2013

Related U.S. Application Data
(60) Provisional application No. 61/762,063, filed on Feb. 7, 2013.

(51) Int. Cl. C04B 28/28

(52) U.S. Cl. CPC C04B 28/28
USPC 524/3

(57) ABSTRACT

A grout composition for application to a tunneling surface is disclosed. The grout composition comprises a mixture including cement and at least one of a hydration stabilizer, a polycarbonate-based high range water reducer, and a viscosity modifier. The grout composition further includes water and a sprayed concrete accelerator. The sprayed concrete accelerator may be included in the composition at the time of application.

### TECHNICAL FIELD OF THE INVENTION

The present invention relates to a cement grout mixture for use in tunneling applications. In particular, the present invention relates to grout mixtures for filling in voids found in precast tunnel segments, wherein the grout mixture is substantially free of bentonite.

### BACKGROUND

Sewer systems generally include a combination of sanitary sewer pipes, carrying sewage from bathrooms, sinks, kitchens, and other plumbing components to wastewater treatment plants, and storm sewer pipes that are designed to help prevent flooding by diverting rainfall runoff and other drainage into nearby rivers and creeks. The inlets to such storm sewers may be found in curbs and low-lying areas. Traditionally, rainfall runoff has been permitted to overflow into surrounding area waterways without requiring treatment at a treatment plant, which helps to lessen the burden on treatment centers. However, the EPA is now requiring all sewer water to be collected and treated, which has significantly increased the demand on treatment plants during times of increased rainwater flow. This substantial increase in water flowing through the pipes can cause the sewer system to backup and potentially overflow.

Underground tunnels have been developed to accommodate this increased demand on treatment plants by waste water during times of heavy rain. The tunnels are built to hold millions of gallons of waste water and safely store this water until the treatment system is able to handle it, such as at night or during dry periods.

In addition to sewers, underground tunnels have been developed for various other purposes, such as transportation, including subway tunnels and traffic diversion tunnels.

The underground tunnels are build from pre-fabricated segments that are sealed together underground. Since, however, the underground space dug to hold the tunnel will not be perfectly sized to the pre-formed tunnel segments, there is generally an annulus space or void between the ground substrate and the tunnel. This void can have negative effects in tunnels, causing the concrete forming the tunnel to crack and break. Such breaks in the concrete may lead to leaks in the tunnel or even collapse of the tunnel completely.

Currently, most tunneling contractors utilize a cement grout mixture with a high water content to fill the void between precast tunnel segments and the substrate. The majority of these grouts consist of cement, fly ash, slag cement, water, and bentonite. Bentonite is a natural material that is used to ‘fatten’ the mixture and reduce the amount of bleed water. Concrete bleeding is the physical migration of water towards the top surface of the concrete. Bleeding is not always favorable as it increases finishing times, produces laitance at the surface, decreases strength, wear resistance and bond strength. In order to use bentonite, a separate pre-slurry is mixed and then added to the cement mixture.

Bentonite is only available from a limited number of suppliers in North America, which makes it expensive and difficult to obtain. Also, a tremendous amount of labor cost is involved in the process of incorporating bentonite, due to the fact that this pre-slurry has to be manually mixed continuously throughout the project.

The present application is directed to reduce or substantially eliminate the use of bentonite in this process through use of less expensive and more accessible chemical admixtures.

### SUMMARY OF THE INVENTION

In accordance with the present invention, a grout mixture is provided that includes cement, at least one hydration stabilizer, at least one polycarboxylate-based high range water reducer, and at least one viscosity modifier. The present grout mixture is capable of forming a slurry when mixed with water. Further, the grout mixture may additionally form a composition for application on a surface by including a sprayed concrete accelerator. The grout mixture preferably achieves a flow of approximately 4 minutes or less (when using a Marsh Cone type testing apparatus) or 12 seconds or less (when using a conventional Grout Flow Cone) over at least a period of 1 hour as a slurry and the grout composition has a minimum strength of at least about 0.1 mpa.

### DETAILED DESCRIPTION OF THE INVENTION

“Grout” as used herein is a mixture of cement, sand, water, and other additives and is generally used to fill cracks and voids, seal joints, embed reinforcement in masonry walls, connect sections of concrete etc.

### Preferable Components of an Exemplary Grout Mixture

### Cement

The grout mixture includes cement, and may include any type of cement commonly known and used in the art, preferably Portland cement. Portland cement is generally included in the grout mixture in an amount ranging from about 15% to about 100%. The cement may be supplemented with fly ash, which is finely divided residue resulting from the combustion of ground or powdered coal. The fly ash may comprise up to about 85% of the cement used in the grout composition.

### Water

The grout mixture, when prepared for use, includes a portion of water, such that the grout mixture forms a slurry. Water is both a reactant and a rheology modifier that permits the grout to flow or be molded into a desired configuration. The water-to-cement ratio may vary based on the total volume of the mixture. According to one embodiment, the water-to-cement ratio varies from 1.0-0.1, and preferably from 0.6-0.3.

### Hydration Stabilizer

The grout mixture may include a “hydration stabilizer,” also known as an extended set retarder, to inhibit cement hydration. Hydration stabilizers are chemical admixtures commonly used in the art for retarding concrete hardening for extended periods of time, such as up to 96 hours, and increasing the mixture's working time. Any conventional hydration stabilizer may be used in the present grout mixture, such as gypsum, polyphosphonic acids or carboxylic acids that contain hydroxyl and/or amino groups. Preferably, the hydration stabilizer is an admixture composition comprising phosphonic acid, sodium hydroxide, and sodium gluconate, such as, for example, Eucon WO, available from Euclid Chemical Company of Cleveland, Ohio.

Incorporating a hydration stabilizer eliminates the need for conventional retarders, which can be unpredictable and cause severe set retardation. In contrast with conventional retarders, hydration stabilizers affect all phases of cement hydration and control the availability of dissolved compounds within the cement paste that promote hydration and setting of the concrete. Although the physical effects of retardation on the concrete are similar to conventional retarders, hydration stabilizer provides a more thorough and controllable extended retardation of the concrete. The functional reliability of conventional concrete retarders is usually restricted to several hours, while hydration stabilizers may be used to predictably delay the hydration of Portland cement in concrete for one or more days.

The hydration stabilizer is preferably included in the present grout mixture in an amount to provide stabilization of the cement for 1-18 hours. To produce this level of stabilization, the hydration stabilizer is generally included in an amount of about 0.5-30 ounces per 100 pounds of cementitious material (oz/cwt) and preferably in an amount about of 2-6 oz/cwt.

### Polycarboxylate-Based High Range Water Reducer

The grout mixture may also include a water reducer to increase flowability of the cementitious compositions and/or reduce water demand. Any conventional water reducer may be used, although high range water reducers are preferred. Water reducers are well known additives for cementitious compositions that allow the water content of the composition to be reduced by up to about 5%. Meanwhile, high range water reducers are capable of enabling reduction in water content by about 12-30%. High-range water reducers are desirable in that they provide concrete with extended workability retention, minimizing the need for jobsite slump adjustments while maintaining consistent air contents from batching to placing of the concrete.

Preferably, the water reducer used in the present grout mixture is a polycarboxylate-based high range water reducer, comprising a polycarboxylate ether with a water reducing effect. Examples of such polycarboxylate-based high range water reducers include Plastol 6200EXT, Plastol Ultra 109, Plastol 5700, Eucon SPJ, Eucon SPC, and Plastol 341, available from Euclid Chemical Company of Cleveland, Ohio. The polycarboxylate-based high range water reducer maintains the typical benefits of polycarboxylate technology, such as high compressive strengths, flexural strength and excellent setting characteristics.

The water reducer is included in an amount that will enable the water content of the grout to be reduced from a typical 2:1 water-to-cement ratio to about 1.0-0.1 ratio, or a preferred 0.6-0.3 ratio, and more preferably about 0.5. To achieve such a water content, the water reducing admixture is included in the mixture in an amount between about 1-15 oz/cwt, and preferably between about 6-8 oz/cwt.

### Viscosity Modifier

The grout mixture may also include a viscosity modifier (also known as a rheology modifier) to reduce or eliminate the bleed water that develops on the surface of the concrete. Viscosity modifiers are well known in the art and commonly used for modifying the rheological properties of the cement paste. Viscosity modifiers change the rheological properties of concrete by increasing the concrete's plastic viscosity (resistance of a concrete to flow under external stress) and yield point (force needed to start the concrete moving). Any conventional viscosity modifier may be used, although an admixture comprising a naphthalene sulfonate and welan gum composition, and/or a polysaccharide composition is preferred. One example of a naphthalene sulfonate and welan gum composition is Visctrol, which is available from Euclid Chemical Company of Cleveland, Ohio. An example of a polysaccharide viscosity modifier composition includes for Eucon ABS, also available from Euclid Chemical Company in Cleveland, Ohio.

The amount of viscosity modifier included in the grout mixture is dependent on the amount of cement present and the desired rheological modification. Preferably, the viscosity modifier is included in the inventive grout mixture in an amount between about 1-15 oz/cwt, and preferably in an amount between about 3-8 oz/cwt. When used in conjunction with high range water reducing admixtures, 18″-28″ (46-71 mm) diameter spreads are achieved without segregation or lowering compressive strengths.

### Sprayed Concrete Accelerator

Once the above described grout mixture is ready for application, a sprayed concrete accelerator (also known as a shotcrete accelerator) may be added to counteract the hydration stabilizer and accelerate setting of the grout when placed in the annulus space of the tunnel lining. Shotcrete is a concrete slurry that is applied under pressure at a high velocity to surfaces through a nozzle. Once the grout mixture components, excluding the sprayed concrete accelerator, are combined, the mixture is pushed to the nozzle of a pump. Compressed air is then introduced at the nozzle to impel the mixture onto the intended surface. The sprayed concrete accelerator is applied at the nozzle because the accelerator sets immediately following impact, and therefore if it was added to the mixture prematurely, the mixture would harden and become unworkable.

Although any conventional sprayed concrete accelerator may be used, preferably the accelerator comprises a sodium silicate; such as, for example, Eucon Sureshot, available from Euclid Chemical Company in Cleveland, Ohio. Alternatively, or in addition to, the accelerator may comprise anhydrous aluminum sulfate and diethanolamine, such as is found in Eucon SureShot AF2LV, or anhydrous aluminum sulfate, diethanolamine, and sepiolite; such as is found in Eucon SureShot AF, also from Euclid Chemical Company in Cleveland, Ohio. The sprayed concrete accelerator is preferably a liquid, high performance cement set accelerator that is capable of providing high early and long term compressive strengths in shotcrete and annulus grout applications.

The sprayed concrete accelerator may be added to the mixture in an amount determined to provide the desired setting and hardening properties. Preferably, the accelerator is included in the mixture between about 0.5 and 10% by weight of total cementitious materials (cmt), and preferably between about 3-5% by weight of cmt.

The exemplary grout mixture, excluding the sprayed concrete accelerator, is mixed according to conventional mixing methods and devices, including drum mixers, central mixers, pan mixers, parastolic mixers, colloidal mixers, etc. The components of the grout mixture should be mixed to a consistency favorable to pumping with grout pumps generally used in annulus grouting applications. The consistency should be determined by the ‘Marsh Cone’ (ASTM D6910) method. The March Cone is a simple device for measuring viscosity from the time it takes a known volume of liquid to flow from the base of a cone through a short tube.

The grout mixture should preferably achieve a flow of not more than 4 minutes, which is industry standard for the amount of time it takes 1000 ml of the grout mixture to flow through the Marsh Cone. If the grout mixture takes greater than 4 minutes to completely flow through the Marsh Cone, it is considered to be failed and not flowable enough for placement in the annulus space. Alternatively, the grout testing method utilized in other areas of construction, ASTM C-939, may be used. The grout mixture, if using this test method, should obtain a flow rate of no more than 20 seconds with 10-12 seconds being considered optimal. To achieve this, the amount of the high range water reducer is selected to achieve the desired or otherwise specified flow, and the amount of hydration stabilizer is selected such that this flow can be maintained for a desired time frame, such as a minimum of 1 hr.

The sprayed concrete accelerator is applied to the mixture at the pump nozzle, as the grout mixture is being pumped through the nozzle at the rate of about 0.5 to 10% by wt. of cmt. The complete grout mixture is then placed into annulus space where it stiffens at a minimum rate of 0.5 psi per shear vane testing in less than 1 hour. Shear vane testing provides an indication of in-situ un-drained shear strength of fine-grained clays and silts or other fine geomaterials, as set forth in ASTM D2573.

Although it has been attempted to make similar grout mixtures in the past, such mixtures lack viscosity modifying materials and utilize typical lignin and napthalene based water reducing materials. These older generation materials are limited in their performance capabilities and therefore not very widely used.

### EXAMPLES

Table 1 illustrates exemplary grout mixtures in accordance with the present disclosure. The mixtures listed indicate that the mix achieved the initial flow requirement of 4 minutes or less and achieved the strength requirements of a particular project. The procedure used in the examples held the initial slump for 1 hour before the accelerator was added. Strength testing was then performed 10 minutes after the addition of the accelerator then check at 2 hours, 3 hours, 1 day and 7 day.

The present exemplary grout mixture achieves good results that meet desired criteria. Such criteria includes achieving a flow of 4 minutes or less through the Marsh Cone and maintenance of that flow for a minimum of 1 hour. Other desired criteria includes achieving a minimum strength of about 0.1 mpa strength within 10 minutes of the accelerator being added to the mix.

TABLE 1

| | | | | | | 3% SureShot @ 2 hours | | | SureShot @ 2 h [symbol] | |
|---|---|---|---|---|---|---|---|---|---|---|
| | Mix 1 | Mix 2 | Mix 3 | Mix 4 | Mix 5 | Mix 6 | Mix 7 | Mix 8 | Mix 9 | Mix 10 |
| Cement (gr) | 700 | 700 | 700 | 1300 | 1300 | 700 | 1000 | 1300 | 1000 | 1300 |
| Fly Ash (gr) | 1300 | 1300 | 1300 | 700 | 700 | 1300 | 1000 | 700 | 1000 | 700 |
| Water (gr) | 760 | 800 | 900 | 900 | 900 | 900 | 900 | 900 | 900 | 900 |
| W/C | 0.38 | 0.4 | 0.45 | 0.45 | 0.45 | 0.45 | 0.45 | 0.45 | 0.45 | 0.45 |
| Eucon WO | 0 | 3 | 3 | 3 | 3 | 2 | 2 | 2 | 2 | 2 |
| oz/cwt | | | | | | | | | | |
| Eucon WO | 0.00 | 3.91 | 3.91 | 3.91 | 3.91 | 2.61 | 2.61 | 2.61 | 2.61 | 2.61 |
| ml | | | | | | | | | | |
| Eucon ABS | 0 | 5.00 | 5.00 | 5.00 | 5.00 | 5.00 | 5.00 | 5.00 | 5.00 | 5.00 |
| oz/cwt | | | | | | | | | | |
| Eucon ABS | 0.00 | 6.51 | 6.51 | 6.51 | 6.51 | 6.51 | 6.51 | 6.51 | 6.51 | 6.51 |
| ml | | | | | | | | | | |
| Plastol 6200 | 14 | 5.00 | 5.00 | 8.00 | 8.00 | 5.00 | 6.00 | 6.00 | 5.00 | 5.00 |
| oz/cwt | | | | | | | | | | |
| Plastol 6200 | 18.24 | 6.51 | 6.51 | 10.42 | 10.42 | 6.51 | 7.82 | 7.82 | 6.51 | 6.51 |
| ml | | | | | | | | | | |
| Batch water | 741.8 | 783.1 | 883.1 | 879.2 | 879.2 | 884.4 | 883.1 | 883.1 | 884.4 | 884.4 |
| (gr) | | | | | | | | | | |
| Initial Flow | 5:30 | 3:40 | 2:25 | 1:52 | 2:02 | 1:57 | 2:08 | 2:01 | 3:05 | 2:31 |
| Notes | | Add | ABS- | | | | | | | |
| | | ABS- | Fail | | | | | | | |
| | | Fail | Add | | | | | | | |
| | | | 6200- | | | | | | | |
| | | | 2:05 | | | | | | | |
| 1 Hour (MPa) | | | | | | 0.15 | 0.19 | 0.24 | 0.21 | 0.25 |
| 2 Hour (MPa) | | | | | | 0.25 | 0.34 | 0.36 | 0.29 | 0.30 |
| 3 Hour (MPa) | | | | | | 0.34 | 0.52 | 0.69 | 0.60 | 0.70 |
| 1 Day (MPa) | | | | | | 1.10 | 1.26 | 1.33 | 1.26 | 1.31 |
| 7 Day (MPa) | | | | | | 2.90 | 3.11 | 3.60 | 3.14 | 3.55 |
| 14 Day (MPa) | | | | | | | | | | |

Key:
Eucon WO: Hydration stabilizer
Eucon ABS: Viscosity Modifier
Plastol 6200: Polycarboxylate-based high range water reducer
Shureshot: Sprayed concrete accelerator [symbol]
indicates data missing or illegible when filed

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept.

What is claimed is:

1. A grout mixture comprising:
cement; and
at least one of a hydration stabilizer; polycarboxylate-based high range water reducer; and viscosity modifier.

2. The grout mixture of claim 1, wherein said mixture further includes water in an amount sufficient to create a slurry having a water-to-cement ratio of between about 1.0-0.1.

3. The grout mixture of claim 2, wherein said hydration stabilizer is included in an amount such that the slurry achieves a flow of 4 minutes or less.

4. The grout mixture of claim 2, wherein said mixture further includes a sprayed concrete accelerator.

5. The grout mixture of claim 4, wherein said grout mixture has a minimum strength of about 0.1 mpa.

6. The grout mixture of claim 4, wherein said sprayed concrete accelerator comprises sodium silicate.

7. The grout mixture of claim 4, wherein said sprayed concrete accelerator comprises one or more of anhydrous aluminum sulfate and diethanolamine.

8. The grout mixture of claim 7, wherein said sprayed concrete accelerator further includes sepiolite.

9. The grout mixture of claim 1, wherein said hydration stabilizer comprises one or more of phosphonic acid, sodium hydroxide, and sodium gluconate.

10. The grout mixture of claim 1, wherein said hydration stabilizer is present in the mixture in an amount of about 0.5-10 oz/cmt.

11. The grout mixture of claim 1, wherein said polycarboxylate-based high range water reducer comprises a polycarboxylate ether.

12. The grout mixture of claim 1, wherein said polycarboxylate-based high range water reducer is present in the mixture in an amount of between about 1-15 oz/cmt.

13. The grout mixture of claim 1, wherein said viscosity modifier includes one or more of naphthalene sulfonate and welan gum.

14. The grout mixture of claim 1, wherein said viscosity modifier comprises a polysaccharide.

15. The grout mixture of claim 1, wherein said viscosity modifier is present in the mixture in an amount of between about 1-15 oz/cmt.

16. The grout mixture of claim 1, wherein said viscosity modifier is present in the mixture in an amount of about 0.5-10% by weight cmt.

17. A method for preparing a grout composition for filling an annulus space comprising:
mixing cement, and at least one of a hydration stabilizer, a polycarboxylate-based high range water reducer, and a viscosity modifier;
introducing water into the grout mixture, forming a slurry with a water-to-cement ratio of about 1.0-0.1;
applying a sprayed concrete accelerator to said slurry forming a grout composition, and
applying said grout composition into an annulus space.

18. The method of claim 17, wherein the hydration stabilizer is included in an amount such that the slurry achieves a flow of not more than 4 minutes.

19. The method of claim 17, wherein upon applying said sprayed concrete accelerator, said composition stiffens at a rate of 0.5 psi per shear vane testing.

20. The method of claim 17, wherein said composition achieves a minimum strength of 0.1 mpa.

21. A grout composition for application to a tunneling surface, said grout composition comprising:
a mixture including:
cement; and
at least one of a hydration stabilizer, a polycarbonate-based high range water reducer, and a viscosity modifier;
water; and
a sprayed concrete accelerator, wherein said sprayed concrete accelerator is included in said composition at the time of application.

22. The grout composition of claim 21, wherein said composition is substantially free of bentonite.

23. The grout composition of claim 22, wherein said composition has a minimum strength of 0.1 mpa.

24. A grout slurry comprising:
a mixture including:
cement; and
at least one of a hydration stabilizer, a polycarbonate-based high range water reducer, and a viscosity modifier; and
water, wherein said slurry comprises a flow of not more than 4 minutes.
